(19) United States
(12) Patent Application Publication
(10) Pub. No.: US 2019/0130341 A1
(43) Pub. Date: May 2, 2019

(54) Human Resource Capital Relocation System

(71) Applicant: ADP, LLC, Roseland, NJ (US)

(72) Inventors: John A. Derrico, Roseland, NJ (US); Laura Maxwell, Gothenburg (SE); Andrew W. Pierce, Atlanta, GA (US); Kulsoom Abdullah, Atlanta, GA (US); Debashis Ghosh, Charlotte, NC (US)

(21) Appl. No.: 15/796,478

(22) Filed: Oct. 27, 2017

(51) Int. Cl. G06Q 10/06; G06F 17/30

(52) U.S. Cl. CPC G06Q 10/063118; G06Q 40/04; G06Q 10/067; G06F 17/30241

(57) ABSTRACT

A method, an apparatus, and a computer program product for digitally presenting a competitive human resources migration model for an organization. A computer system determines migration metrics from the employee migration data. The computer system determines migration events for the benchmark organizations based on subsets of the migration metrics. The computer system determines an effect of the migration events on business metrics for the benchmark organizations. The computer system determines the competitive human resources migration model for the organization based on the effect on the business metrics. The computer system digitally presents the competitive human resources migration model for the organization.

### BACKGROUND INFORMATION

### 1. Field

The present disclosure relates generally to an improved computer system and, in particular, to a method and apparatus for accessing information in a computer system. Still more particularly, the present disclosure relates to a method, a system, and a computer program product for determining and presenting a competitive human resources migration model for an organization.

### 2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance plans, wellness plans, and other programs and organizations using an employee information system. As yet another example, an information system may be used to hire new employees, assign employees to projects, perform reviews for employees, and other suitable operations for the organization. As another example, a research department in the organization may use an information system to store and analyze information to research new products, analyze products, or for other suitable operations.

Currently used information systems include databases. These databases store information about the organization. For example, these databases store information about employees, products, research, product analysis, business plans, and other information about the organization.

Information about the employees may be searched and viewed to perform various operations within an organization. However, this type of information in currently used databases may be cumbersome and difficult to access relevant information in a timely manner that may be useful to performing an operation for the organization. For example, understanding how the relocation of employees effects business metrics may be desirable when performing operations such as identifying new hires, selecting teams for projects, and other operations in the organization. However, relevant information often cannot be determined for when formulating relocation strategies of human resource capital. Therefore, relevant information is often excluded from the analysis and performance of the operation. Furthermore, identifying appropriate relocation strategies for companies of a particular size and industry may take more time than desired in an information system.

Therefore, it would be desirable to have a method and apparatus that take into account at least some of the issues discussed above, as well as other possible issues. For example, it would be desirable to have a method and apparatus that overcome the technical problem of presenting a potentially competitive human resource migration model for an organization.

### SUMMARY

An embodiment of the present disclosure provides a method for digitally presenting a competitive human resources migration model for an organization. A computer system determines migration metrics from the employee migration data. The computer system determines migration events for the benchmark organizations based on subsets of the migration metrics. The computer system determines an effect of the migration events on business metrics for the benchmark organizations. The computer system determines the competitive human resources migration model for the organization based on the effect on the business metrics. The computer system digitally presents the competitive human resources migration model for the organization.

Another embodiment of the present disclosure provides a computer system comprising a hardware processor, a display system, and a migration modeler in communication with the hardware processor and the display system. The migration modeler determines migration metrics from the employee migration data. The migration modeler determines migration events for the benchmark organizations based on subsets of the migration metrics. The migration modeler determines an effect of the migration events on business metrics for the benchmark organizations. The migration modeler determines the competitive human resources migration model for the organization based on the effect on the business metrics. The migration modeler digitally presents the competitive human resources migration model for the organization on the display system.

Yet another embodiment of the present disclosure provides a computer program product for digitally presenting a competitive human resources migration model for an organization. The computer program product comprises a computer readable storage media and program code, stored on the computer readable storage media. The program code includes first program code for determining employee migration data for benchmark organizations. The program code includes second program code for determining, migration metrics from the employee migration data. The program code includes third program code for determining migration events for the benchmark organizations based on subsets of the migration metrics. The program code includes fourth program code for determining an effect of the migration events on business metrics for the benchmark organizations. The program code includes fifth program code for determining the competitive human resources migration model for the organization based on the effect on the business metrics. The program code includes sixth program code for digitally presenting the competitive human resources migration model for the organization.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a human resources migration environment depicted in accordance with an illustrative embodiment;

FIG. 2 is an illustration of a block diagram of a data flow for determining a set of benchmark organizations within a human resource modeling system in accordance with an illustrative embodiment;

FIG. 3 is an illustration of a block diagram of a data flow for determining employee migration data within a human resource modeling system in accordance with an illustrative embodiment;

FIG. 4 is an illustration of a block diagram of a data flow for determining migration metrics within a human resource modeling system in accordance with an illustrative embodiment;

FIG. 5 is an illustration of a block diagram of a data flow for determining migration events within a human resource modeling system in accordance with an illustrative embodiment;

FIG. 6 is an illustration of a diagram of migration events determined from a first subset of migration metrics in accordance with an illustrative embodiment;

FIG. 7 is an illustration of a diagram of migration events determined from a second subset of migration metrics in accordance with an illustrative embodiment;

FIG. 8 is an illustration of a chart illustrating relationships between migration events in accordance with an illustrative embodiment;

FIG. 9 is an illustration of a block diagram of a data flow for determining migration metrics based on a number of correlation policies within a human resource modeling system in accordance with an illustrative embodiment;

FIG. 10 is an illustration of a graph of a first migration metric determined based on a correlation policy in accordance with an illustrative embodiment;

FIG. 11 is an illustration of a graph of a second migration metric determined based on a correlation policy in accordance with an illustrative embodiment;

FIG. 12 is an illustration of a graph of a third migration metric determined based on a correlation policy in accordance with an illustrative embodiment;

FIG. 13 is an illustration of a graph of a fourth migration metric determined based on a correlation policy in accordance with an illustrative embodiment;

FIG. 14 is an illustration of a block diagram of a data flow for determining an effect of migration events on business metrics within a human resource modeling system in accordance with an illustrative embodiment;

FIG. 15 is an illustration of a block diagram of a data flow for determining an effect of migration events on business metrics within a human resource modeling system in accordance with an illustrative embodiment;

FIG. 16 is an illustration of a block diagram of a data flow for digitally presenting a competitive human resources migration model within a human resource modeling system in accordance with an illustrative embodiment;

FIG. 17 is an illustration of a first screen of a graphical user interface migration model for digitally presenting a competitive human resources migration model in accordance with an illustrative embodiment;

FIG. 18 is an illustration of a second screen of a graphical user interface migration model for digitally presenting a competitive human resources migration model in accordance with an illustrative embodiment;

FIG. 19 is an illustration of a third screen of a graphical user interface migration model for digitally presenting a competitive human resources migration model in accordance with an illustrative embodiment;

FIG. 20 is an illustration of a fourth screen of a graphical user interface migration model for digitally presenting a competitive human resources migration model in accordance with an illustrative embodiment;

FIG. 21 is an illustration of a fifth screen of a graphical user interface migration model for digitally presenting a competitive human resources migration model in accordance with an illustrative embodiment;

FIG. 22 is an illustration of a sixth screen of a graphical user interface migration model for digitally presenting a competitive human resources migration model in accordance with an illustrative embodiment;

FIG. 23 is an illustration of a seventh screen of a graphical user interface migration model for digitally presenting a competitive human resources migration model in accordance with an illustrative embodiment;

FIG. 24 is an illustration of a flowchart of a process for digitally presenting a competitive human resources migration model in accordance with an illustrative embodiment;

FIG. 25 is an illustration of a flowchart of a process for determining a set of benchmark organizations in accordance with an illustrative embodiment;

FIG. 26 is an illustration of a flowchart of a process for determining migration events for a set of benchmark organizations in accordance with an illustrative embodiment;

FIG. 27 is an illustration of a flowchart of a process for performing an operation for an organization based on a competitive human resources migration model in accordance with an illustrative embodiment; and

FIG. 28 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that an employer may need information about the effects of employee relocations on business metrics when performing certain operations. Furthermore, identifying appropriate relocation strategies for companies of a particular size and industry may also be desirable. The illustrative embodiments also recognize and take into account that searching information systems for successful relocation strategies, and identifying the effects of the strategies, may be more cumbersome and time-consuming than desirable.

The illustrative embodiments also recognize and take into account that digitally presenting a potentially competitive human resources migration model for an organization may facilitate accessing information about appropriate relocation strategies when performing operations for an organization. The illustrative embodiments also recognize and take into account that identifying a potentially competitive human resources migration model may still be more difficult than desired.

Thus, the illustrative embodiments provide a method and apparatus for digitally presenting a competitive human resources migration model for an organization. In one illustrative example, a computer system determines employee migration data for benchmark organizations. The computer system determines migration metrics from the employee migration data. The computer system determines migration events for the benchmark organizations based on subsets of the migration metrics. The computer system determines an effect of the migration events on business metrics for the benchmark organizations. The computer system determines the competitive human resources migration model for the organization based on the effect on the business metrics. The computer system digitally presents the competitive human resources migration model for the organization.

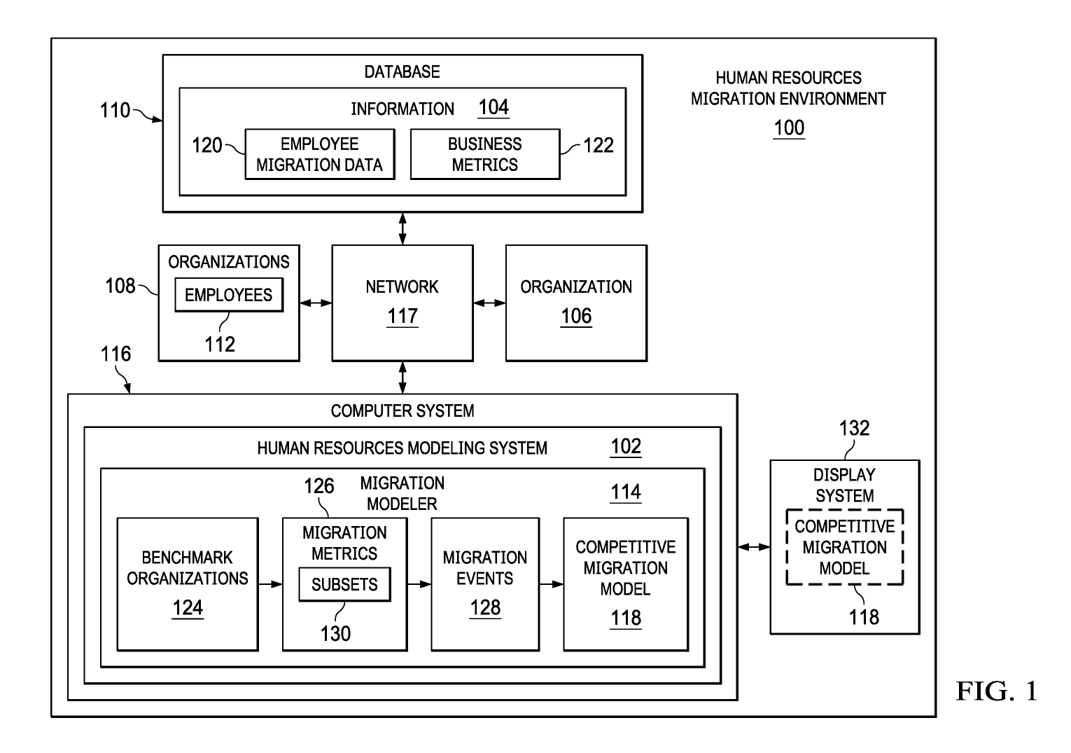

With reference now to the figures and, in particular, with reference to FIG. 1, an illustration of a block diagram of a human resources migration environment is depicted in accordance with an illustrative embodiment. As depicted, human resources migration environment 100 includes human resources modeling system 102.

Human resources modeling system 102 may take different forms. For example, human resources modeling system 102 may be selected from one of an employee information system, a research information system, a sales information system, an accounting system, a payroll system, a human resources system, or some other type of information system that stores and provides access to information 104.

Information 104 can include information about organization 106 and organizations 108. Information 104 may include, for example, at least one of information about people, products, research, product analysis, business plans, financials, or other information relating to organization 106 and organizations 108. As depicted, information 104 is stored on database 110.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Organization 106 and organizations 108 may be, for example, a corporation, a partnership, a charitable organization, a city, a government agency, or some other suitable type of organization. As depicted, organizations 108 includes employees 112.

As depicted, employees 112 are people who are employed by or associated with organizations 108. For example, employees 112 can include at least one of employees, administrators, managers, supervisors, and third parties associated with organizations 108.

In this illustrative example, human resources modeling system 102 includes a number of different components. As depicted, human resources modeling system 102 includes migration modeler 114. Migration modeler 114 may be implemented in computer system 116.

Computer system 116 is a physical hardware system and includes one or more data processing systems. When more than one data processing system is present, those data processing systems may be in communication with each other using a communications medium. The communications medium may be a network, such as network 117. The data processing systems may be selected from at least one of a computer, a server computer, a workstation, a tablet computer, a laptop computer, a mobile phone, or some other suitable data processing system.

In this illustrative example, migration modeler 114 generates competitive migration model 118. Competitive migration model 118 is a suggested human resource capital migration strategy for organization 106 based on information 104 about organizations 108. As depicted, information 104 includes employee migration data 120 and business metrics 122.

By generating competitive migration model 118, migration modeler 114 enables the performance of operations by organization 106 that may promote desired changes to business metrics of organization 106. For example, competitive migration model 118 allows organization 106 to perform operations based on changes to business metrics 122 of organizations 108.

Migration modeler 114 may be implemented in software, hardware, firmware, or a combination thereof. When software is used, the operations performed by migration modeler 114 may be implemented in program code configured to run on hardware, such as a processor unit. When firmware is used, the operations performed by migration modeler 114 may be implemented in program code and data and stored in persistent memory to run on a processor unit. When hardware is employed, the hardware may include circuits that operate to perform the operations in migration modeler 114.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

Migration modeler 114 determines employee migration data 120 for benchmark organizations 124. Benchmark organizations 124 are ones of organizations 108. Migration modeler 114 can identify benchmark organizations 124 based on information 104 about organizations 108.

Employee migration data 120 is information 104 about a geographic relocation of employees 112 of organizations 108 over a given time period. For each of organizations 108, employee migration data 120 includes information 104 about employees 112 that relocate to or from a particular geographic location.

Migration modeler 114 determines migration metrics 126 from employee migration data 120 of benchmark organizations 124. Migration metrics 126 can include, for example, but not limited to, metrics relating to a number of employees 112 that relocate to a geographic location, a number of employees 112 that relocate from a geographic location, a net number of employees 112 that relocate for a geographic location, a number of geographic locations that employees 112 relocate to, a number of geographic locations that employees 112 relocate from, a maximum number of employees 112 that relocate to a particular geographic location, and a maximum number of employees 112 that relocate from a particular geographic location, as well as other suitable metrics.

Migration modeler 114 determines migration events 128 for benchmark organizations 124. Migration events 128 are implementations of human capital resources relocation strategies by benchmark organizations 124. For example, one of migration events 128 may be a relocation of employees 112 from one centralized location to a number of smaller satellite locations. Another one of migration events 128 may be a relocation of employees 112 from a number of smaller satellite locations to one centralized location. Still further, one of migration events 128 may be a relocation of employees 112 from one centralized location to another centralized location.

In this illustrative example, migration modeler 114 determines migration events 128 for benchmark organizations 124 based on subsets 130 of migration metrics 126. Subsets 130 are one or more of migration metrics 126.

Migration modeler 114 determines an effect of migration events 128 on business metrics 122 for benchmark organizations 124. The effect can be a change to one or more of business metrics 122 that attributed to migration events 128.

Based on the effect on business metrics 122, migration modeler 114 determines competitive migration model 118 for organization 106. Competitive migration model 118 is a suggested human capital resources relocation strategy for organization 106 based on changes in business metrics 122 attributed to migration events 128 of benchmark organizations 124.

Migration modeler 114 then digitally presents competitive migration model 118 for organization 106. In this illustrative example, computer system 116 can display competitive migration model 118 on display system 132. In this illustrative example, display system 132 can be a group of display devices. A display device in display system 132 may be selected from one of a liquid crystal display (LCD), a light emitting diode (LED) display, an organic light emitting diode (OLED) display, and other suitable types of display devices.

By determining competitive migration model 118, migration modeler 114 enables more efficient performance of operations for organization 106. For example, organization 106 can perform operations, such as, but not limited to, at least one of hiring, benefits administration, payroll, performance reviews, forming teams for new products, assigning research projects, or other suitable operations consistent with competitive migration model 118.

Operations that are performed consistent with competitive migration model 118 allows organization 106 to implement a human capital resources relocation strategy based on changes in business metrics 122 attributed to migration events 128 of benchmark organizations 124. For example, competitive migration model 118 allows organization 106 to perform operations in a manner that is consistent with the human capital resources relocation strategies of benchmark organizations 124 based on effects of migration events 128 on business metrics 122.

In this illustrative example, human resource modeling system 102 digitally presents competitive migration model 118 for organization 106. Migration modeler 114 determines employee migration data 120 for benchmark organizations 124. Migration modeler 114 determines migration metrics 126 from employee migration data 120. Migration modeler 114 determines migration events 128 for benchmark organizations 124 based on subsets 130 of migration metrics 126. Migration modeler 114 determines an effect of migration events 128 on business metrics 122 for benchmark organizations 124. Migration modeler 114 determines competitive migration model 118 for organization 106 based on the effect on business metrics 122. Migration modeler 114 digitally presents competitive migration model 118 for organization 106 on display system 132.

The illustrative example in FIG. 1 and the examples in the other subsequent figures provide one or more technical solutions to overcome a technical problem of determining a competitive human resources capital relocation strategy for an organization that make the performance of operations for an organization more cumbersome and time-consuming than desired. For example, when organization 106 performs operations consistent with competitive migration model 118, organization 106 implements a human capital resources relocation strategy in a manner that is consistent with migration events 128 of benchmark organizations 124 based on changes in business metrics 122 attributed to migration events 128 of benchmark organizations 124.

In this manner, the use of human resources modeling system 102 has a technical effect of determining competitive migration model 118 based on migration events 128 of benchmark organizations 124, thereby reducing time, effort, or both in the performance of operations for organization 106. In this manner, operations performed for organization 106 may be performed more efficiently as compared to currently used systems that do not include human resources modeling system 102. For example, operations such as, but not limited to, at least one of hiring, benefits administration, payroll, performance reviews, forming teams for new products, assigning research projects, or other suitable operations for organization 106, performed consistently with competitive migration model 118 allows organization 106 to implement a human capital resources relocation strategy based on changes in business metrics 122 attributed to migration events 128 of benchmark organizations 124.

As a result, computer system 116 operates as a special purpose computer system in which human resources modeling system 102 in computer system 116 enables migration modeler 114 to determine and digitally present competitive migration model 118 for organization 106. Migration modeler 114 determines employee migration data 120 for benchmark organizations 124. Migration modeler 114 determines migration metrics 126 from employee migration data 120. Migration modeler 114 determines migration events 128 for benchmark organizations 124 based on subsets 130 of migration metrics 126. Migration modeler 114 determines an effect of migration events 128 on business metrics 122 for benchmark organizations 124. Migration modeler 114 determines competitive migration model 118 for organization 106 based on the effect on business metrics 122. Migration modeler 114 digitally presents competitive migration model 118 for the organization on display system 132.

When competitive migration model 118 is determined in this manner, competitive migration model 118 may be relied upon to perform operations for organization 106. Operations can be performed in a manner that is consistent with migration events 128 of benchmark organizations 124 based on changes in business metrics 122 attributed to migration events 128 of benchmark organizations 124.

Thus, human resource modeling system 102 transforms computer system 116 into a special purpose computer system as compared to currently available general computer systems that do not have human resource modeling system 102. Currently used general computer systems do not reduce the time or effort needed to determine a potentially competitive migration model 118 based on employee migration data 120 and business metrics 122 of benchmark organizations 124. Further, currently used general computer systems do not provide for determining competitive migration model 118 for organization 106 based on migration events 128 of organizations 108.

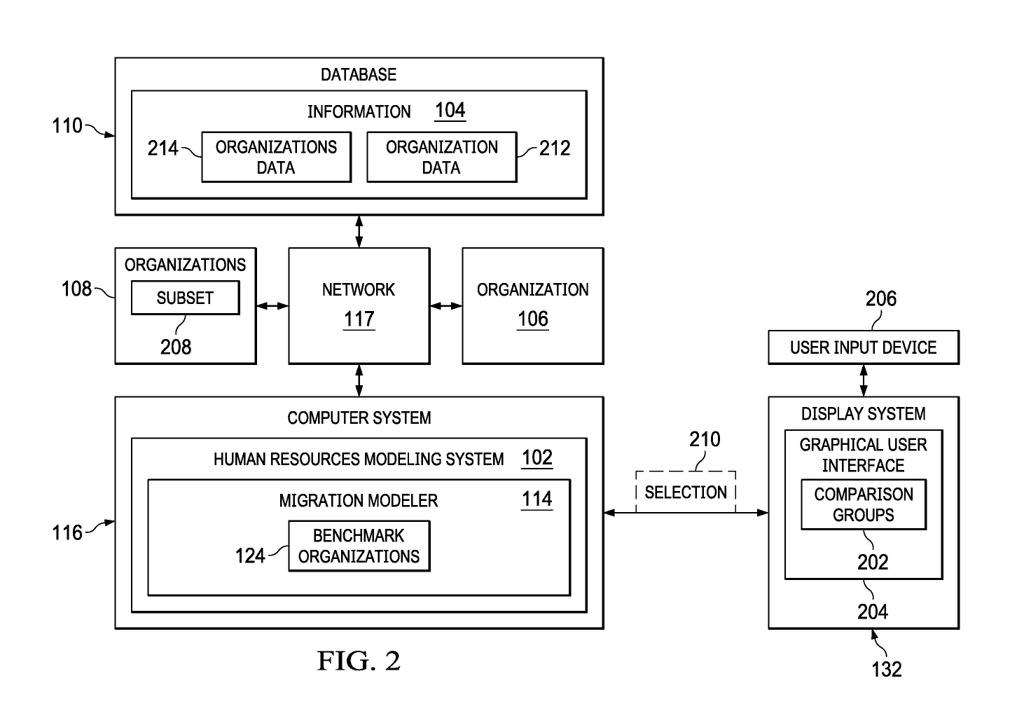

With reference next to FIG. 2, an illustration of a block diagram of a data flow for determining a set of benchmark organizations within a human resource modeling system is depicted in accordance with an illustrative embodiment. As depicted, human resources modeling system 102 is human resources modeling system 102 of FIG. 1.

In this illustrative example, comparison groups 202 are displayed in graphical user interface 204 on display system 132. An operator may interact with graphical user interface 204 through user input generated by one or more of user input device 206, such as, for example, a mouse, a keyboard, a trackball, a touchscreen, a stylus, or some other suitable type of input device.

In this illustrative example, comparison groups 202 are categorical filters that can be applied when determining benchmark organizations 124. For example, comparison groups 202 may include at least one of a country, an industry, a location, a union, a company size, a peer group, a talent competitor, or other groups that may be used to identify subset 208 of organizations 108.

In this illustrative example, migration modeler 114 receives selection 210. Selection 210 is a selection of one of comparison groups 202. In this illustrative example, a user can select between different ones of comparison groups 202 by interacting with an appropriate graphical element in graphical user interface 204 via user input device 206.

Based on selection 210 of one of comparison groups 202, migration modeler 114 correlates organization data 212 for organization 106 to organizations data 214 to identify subset 208 of organizations 108. In this illustrative example, subset 208 can be identified based on similarities between organization data 212 and organizations data 214 for one of comparison groups 202.

Migration modeler 114 then determines benchmark organizations 124 from subset 208 of organizations 108. In this illustrative example, benchmark organizations 124 may be one or more of subset 208 of organizations 108.

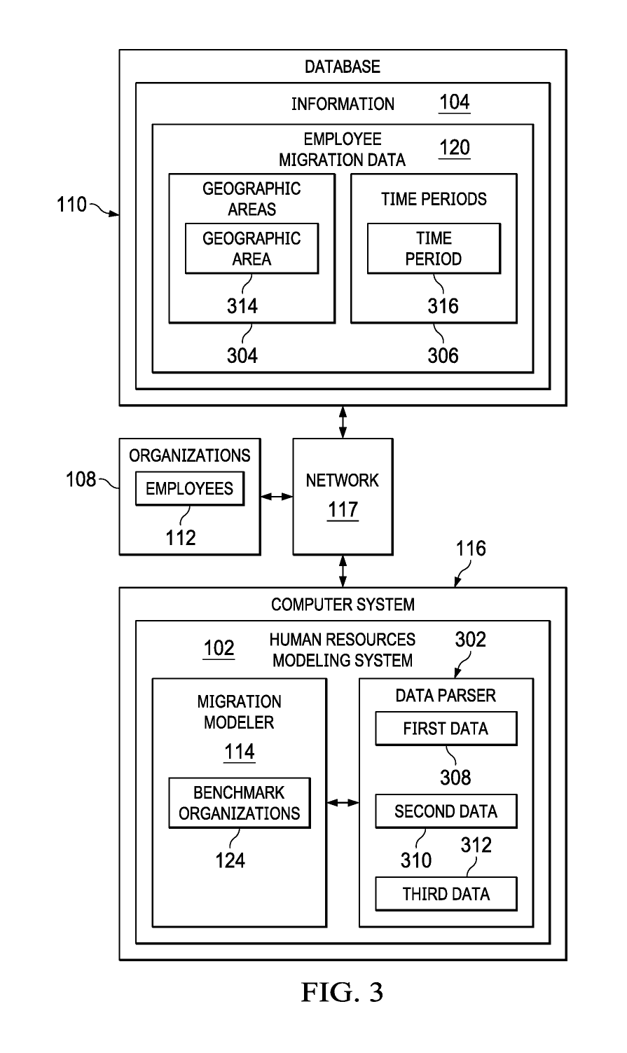

With reference next to FIG. 3, an illustration of a block diagram of a data flow for determining employee migration data within a human resource modeling system is depicted in accordance with an illustrative embodiment. As depicted, human resources modeling system 102 is human resources modeling system 102 of FIG. 1.

In this illustrative example, human resources modeling system 102 includes a number of different components. As depicted, human resources modeling system 102 includes migration modeler 114 and data parser 302.

Data parser 302 identifies and parses information 104 for employee migration data 120 for benchmark organizations 124. In this illustrative example, employee migration data 120 can include migration data for geographic areas 304 and migration data for time periods 306.

Geographic areas 304 are data indicating geolocations which employees 112 of benchmark organizations 124 relocate to or from during a relocation event. Geographic areas 304 can be, for example, but not limited to, a city, a metropolitan area, a state, or a country. Time periods 306 are data indicating a particular time that employees 112 of benchmark organizations 124 relocate during a relocation event.

In this illustrative example, data parser 302 identifies a number of different information from employee migration data 120. As depicted, data parser 302 identifies first data 308, second data 310, and third data 312.

First data 308 is information identified from employee migration data 120 that measures a number of employees 112 of benchmark organizations 124 that migrate into geographic areas 304 over time periods 306. First data 308 can be specific to one or more of geographic areas 304 and time periods 306. For example, first data 308 can measure a number of employees 112 of benchmark organizations 124 that migrate into geographic area 314 over time period 316.

Second data 310 is information identified from employee migration data 120 that measures a number of employees 112 for benchmark organizations 124 that migrate away from geographic areas 304 over time periods 306. Second data 310 can be specific to one or more geographic areas 304 and time periods 306. For example, second data 310 can measure a number of employees 112 of benchmark organizations 124 that migrate away from geographic area 314 over time period 316.

Third data 312 is information identified from employee migration data 120 that measures a net migration of employees 112 of benchmark organizations 124 in geographic areas 304 over time periods 306. Third data 312 can be specific to one or more geographic areas 304 and time periods 306. For example, third data 312 can measure a net migration of employees 112 of benchmark organizations 124 in geographic area 314 over time period 316.

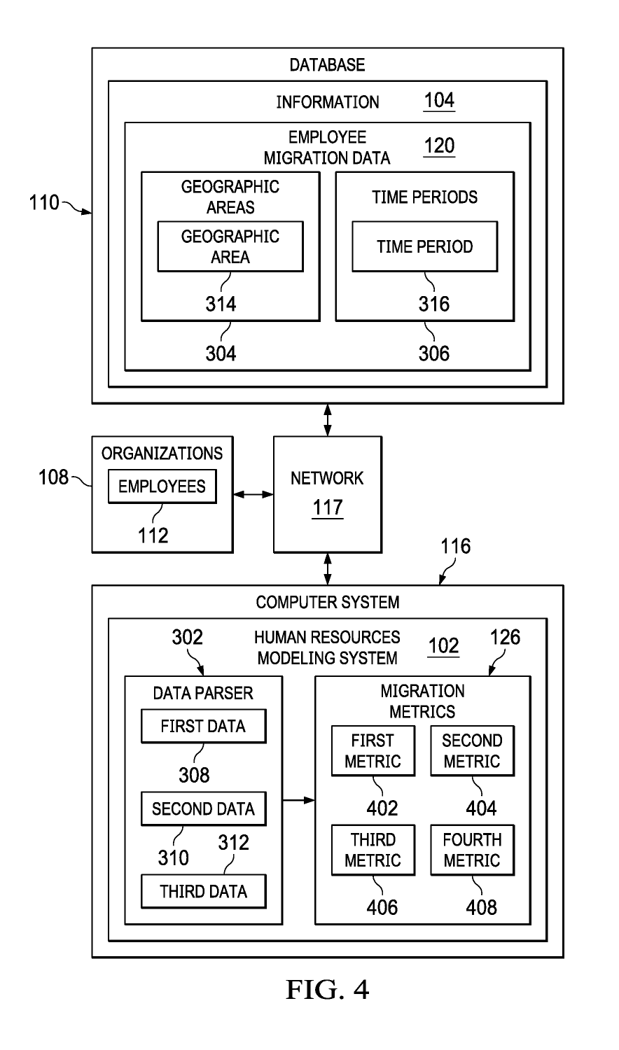

With reference next to FIG. 4, an illustration of a block diagram of a data flow for determining migration metrics within a human resource modeling system is depicted in accordance with an illustrative embodiment. As depicted, human resources modeling system 102 is human resources modeling system 102 of FIG. 1.

Migration modeler 114 of FIG. 1 determines migration metrics 126 from employee migration data 120 of benchmark organizations 124, shown in block form in FIG. 1. In this illustrative example, migration modeler 114 determines migration metrics 126 based on first data 308, second data 310, and third data 312 identified by data parser 302.

Migration metrics 126 can include a number of different metrics. As depicted, migration metrics 126 includes first metric 402, second metric 404, third metric 406, and fourth metric 408.

In this illustrative example, first metric 402 is a measure of a number of geographic areas 304 into which employees 112 of benchmark organizations 124, shown in block form in FIG. 1, migrate over time period 316. Second metric 404 is a measure of a number of geographic areas 304 away from which employees 112 of the set of benchmark organizations 124, shown in block form in FIG. 1, migrate over time period 316.

Third metric 406 is a measure of a maximum number of employees 112 of benchmark organizations, shown in block form in FIG. 1, that migrated to geographic area 314 over time period 316. In the context of third metric 406, more of employees 112 migrated to geographic area 314 than to any others of geographic areas 304. Therefore, “a maximum number of employees” is the number of employees 112 of benchmark organizations 124, shown in block form in FIG. 1, that migrated to geographic area 314 over time period 316.

Fourth metric 408 is a measure of a maximum number of employees 112 of benchmark organizations 124, shown in block form in FIG. 1, that migrated away from geographic area 314 over time period 316. In the context of fourth metric 408, more employees 112 migrated away from geographic area 314 than from any others of geographic areas 304. Therefore, “a maximum number of employees” is the number of employees 112 of benchmark organizations 124, shown in block form in FIG. 1, that migrated away from geographic area 314 over time period 316.

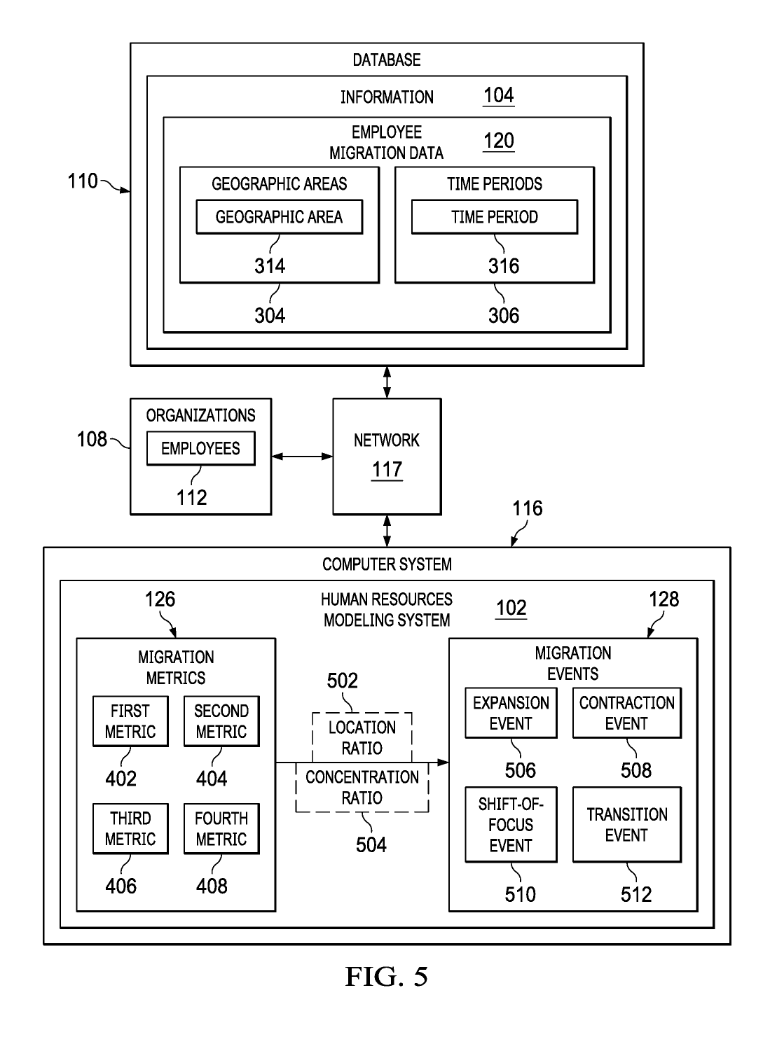

With reference next to FIG. 5, an illustration of a block diagram of a data flow for determining migration events within a human resource modeling system is depicted in accordance with an illustrative embodiment. As depicted, human resources modeling system 102 is human resources modeling system 102 of FIG. 1.

Migration modeler 114 determines migration events 128 for benchmark organizations 124, shown in block form in FIG. 1. In this illustrative example, migration modeler 114 determines migration events 128 for benchmark organizations 124 based on subsets 130 of migration metrics 126. Subsets 130 are one or more of migration metrics 126.

In this illustrative example, migration modeler 114 determines migration events 128 based on ratios between subsets 130. For example, migration modeler 114 can determine migration events 128 based on location ratio 502 and concentration ratio 504.

Migration modeler 114 determines location ratio 502 for benchmark organizations 124 of FIG. 1, wherein location ratio 502 is based on first metric 402 and second metric 404. In this illustrative example, location ratio 502 is determined from a subset of migration metrics 126 consisting of first metric 402 and second metric 404. Location ratio 502 is a ratio between first metric 402 and second metric 404.

Migration modeler 114 determines concentration ratio 504 for benchmark organizations 124 of FIG. 1, wherein concentration ratio 504 is based on third metric 406 and fourth metric 408. In this illustrative example, concentration ratio 504 is determined from a subset of migration metrics 126 consisting of third metric 406 and fourth metric 408. Concentration ratio 504 is a ratio of third metric 406 and fourth metric 408.

Migration events 128 include a number of different events. As depicted, migration events 128 include expansion event 506, contraction event 508, shift-of-focus event 510, and transition event 512.

Expansion event 506 is a relocation of employees 112 by benchmark organizations 124 of FIG. 1 from one centralized location, such as geographic area 314, to a number of smaller satellite locations, such as multiple ones of geographic areas 304. Contraction event 508 is a relocation of employees 112 by benchmark organizations 124 of FIG. 1 from a number of smaller satellite locations, such as multiple ones of geographic areas 304, to one centralized location, such as geographic area 314.

Shift-of-focus event 510 is a relocation of employees 112 by benchmark organizations 124 of FIG. 1 from one centralized location, such as geographic area 314, to another centralized location, such as another one of geographic areas 304. Transition event 512 is a relocation of employees 112 by benchmark organizations 124 of FIG. 1 that does not follow the relocation patterns of expansion event 506, contraction event 508, or shift-of-focus event 510.

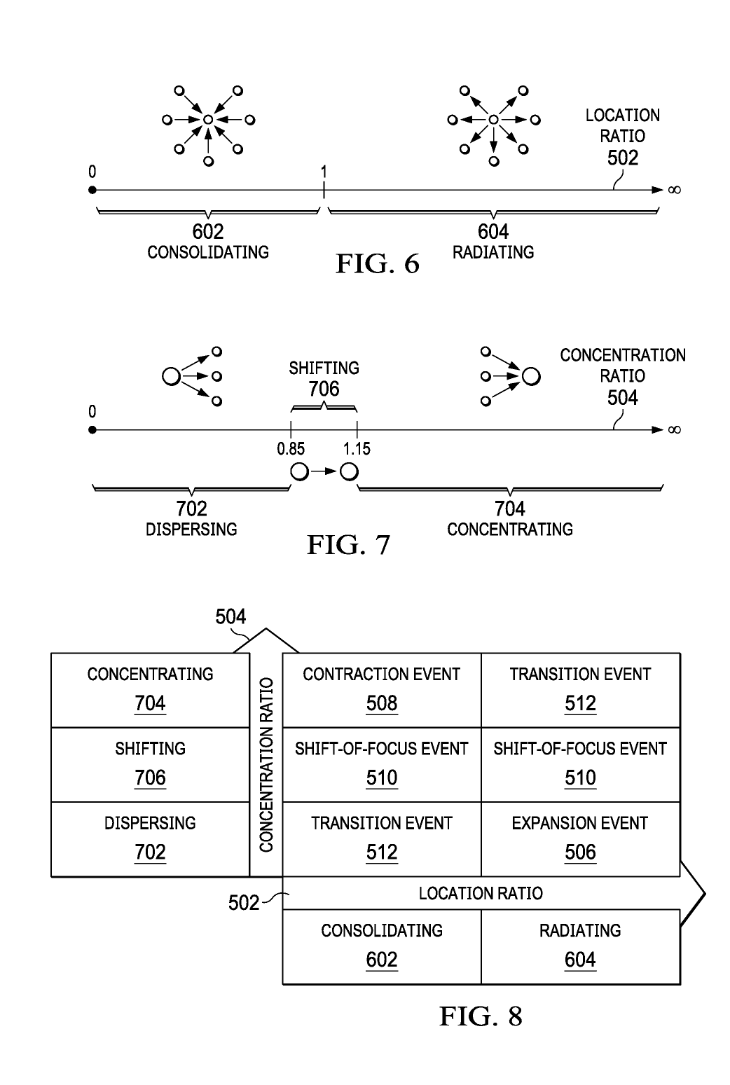

With reference to FIG. 6, an illustration of a diagram of location type migrations determined from a first subset of migration metrics is depicted in accordance with an illustrative embodiment.

In this illustrative example, location ratio 502 can be defined by the equation:

Location ratio=(n_mig_to+1)/(n_mig_from+1);

wherein:

n_mig_to is first metric 402 of FIG. 4; and

n_mig_from is second metric 404 of FIG. 4.

In this illustrative example, as location ratio 502 approaches zero, a company has very few locations that employees are migrating to relative to locations that employees are migrating from. Therefore, as location ratio 502 approaches zero, the company undergoes consolidating type 602 of migration.

Conversely, as location ratio 502 approaches infinity, a company has more locations that employees are migrating to relative to locations that employees are migrating from. Therefore, as location ratio 502 approaches infinity, the company undergoes radiating type 604 of migration.

With reference next to FIG. 7, an illustration of a diagram of concentration type migrations determined from a second subset of migration metrics is depicted in accordance with an illustrative embodiment.

In this illustrative example, concentration ratio 504 can be defined by the equation:

Concentration ratio=(max_mig_to+1)/(max_mig_from+1);

wherein:

max_mig_to is third metric 406 of FIG. 4; and

max_mig_from is fourth metric 408 of FIG. 4.

In this illustrative example, as concentration ratio 504 approaches zero, more employees are migrating away from an individual location, such as geographic area 314 of FIG. 3, than employees are migrating to any other location, such as others of geographic areas 304 of FIG. 3. Therefore, as concentration ratio 504 approaches zero, the company undergoes dispersing type 702 of migration.

Conversely, as concentration ratio 504 approaches infinity, more employees are migrating to an individual location, such as geographic area 314 of FIG. 3, than employees are migrating away from any other location, such as others of geographic areas 304 of FIG. 3. Therefore, as concentration ratio 504 approaches infinity, the company undergoes concentrating type 704 of migration.

As concentration ratio 504 approaches a value of one, a company has two equally large migration locations. A similar number of employees are migrating to a first location, such as geographic area 314 of FIG. 3, as a second number of employees that are migrating away from a second location, such as one other of geographic areas 304 of FIG. 3. Therefore, as concentration ratio 504 approaches value of one, the company undergoes shifting type 706 of migration.

With reference next to FIG. 8, a chart illustrating relationships between migration events is depicted in accordance with an illustrative embodiment. In this illustrative example, migration modeler 114 of FIG. 1 determines that benchmark organizations 124 undergo transition event 512 when location ratio 502 indicates consolidating type 602 of migration, and concentration ratio 504 indicates dispersing type 702 of migration. Similarly, migration modeler 114 of FIG. 1 determines that benchmark organizations 124 undergo transition event 512 when location ratio 502 indicates radiating type 604 of migration and concentration ratio 504 indicates concentrating type 704 of migration.

In this illustrative example, migration modeler 114 of FIG. 1 determines that benchmark organizations 124 undergo shift-of-focus event 510 when location ratio 502 indicates consolidating type 602 of migration and concentration ratio 504 indicates shifting type 706 of migration. Similarly, migration modeler 114 of FIG. 1 determines that benchmark organizations 124 undergo shift-of-focus event 510 when location ratio 502 indicates radiating type 604 of migration and concentration ratio 504 indicates shifting type 706 of migration.

In this illustrative example, migration modeler 114 of FIG. 1 determines that benchmark organizations 124 undergo contraction event 508 when location ratio 502 indicates consolidating type 602 of migration and concentration ratio 504 indicates concentrating type 704 of migration. Migration modeler 114 of FIG. 1 determines that benchmark organizations 124 undergo expansion event 506 when location ratio 502 indicates radiating type 604 of migration and concentration ratio 504 indicates dispersing type 702 of migration.

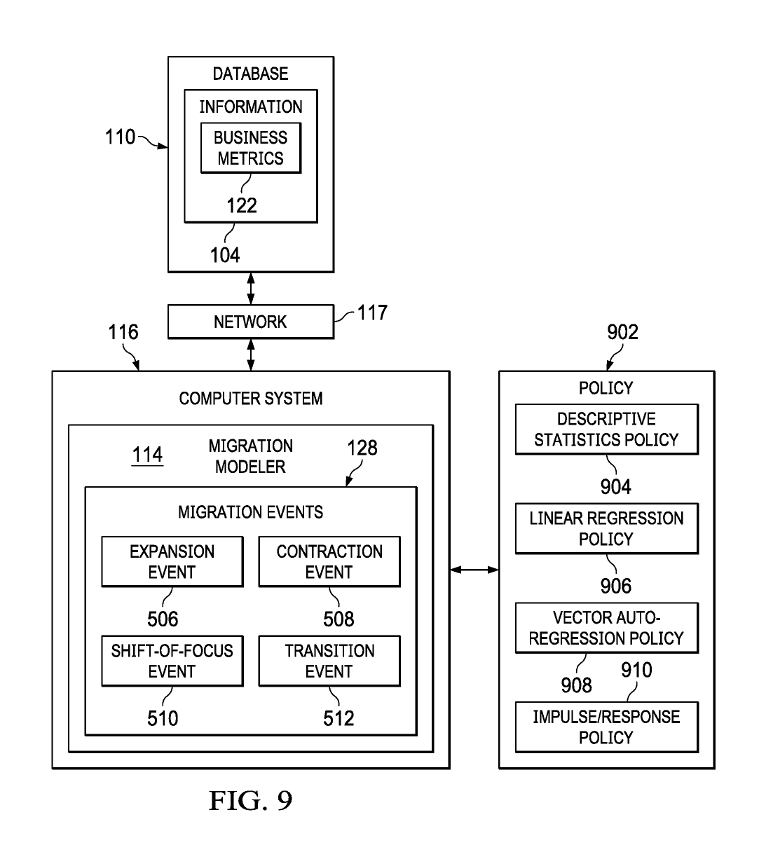

With reference next to FIG. 9, an illustration of a block diagram of a data flow for determining migration metrics based on a number of correlation policies within a human resource modeling system is depicted in accordance with an illustrative embodiment.

Migration modeler 114 determines an effect of migration events 128 on business metrics 122 of benchmark organizations 124 of FIG. 1. The effect can be a change to one or more of business metrics 122 that attributed to migration events 128.

In this illustrative example, migration modeler 114 determines an effect of migration events 128 on business metrics 122 using one or more of policy 902. In this illustrative example, policy 902 includes one or more rules that are used to determines an effect of migration events 128 on business metrics 122 for benchmark organizations 124. Policy 902 also may include data used to apply one or more rules.

Policy 902 can include a number of policies. As depicted, policy 902 includes descriptive statistics policy 904, linear regression policy 906, vector auto-regression policy 908, and impulse/response policy 910.

In an illustrative example, migration modeler 114 determines an effect of migration events 128 on business metrics 122 using descriptive statistics policy 904. Descriptive statistics policy 904 determines an effect of migration events 128 by examining business metrics 122 of benchmark organizations 124. Business metrics 122 can include financial indicators for benchmark organizations 124 that experienced the different types of migration events 128 in time period 316. Descriptive statistics policy 904 allows migration modeler 114 to determine if there is an immediate response to migration events 128 in terms of financial growth/efficiencies of benchmark organizations 124, as reflected in business metrics 122.

In an illustrative example, migration modeler 114 determines an effect of migration events 128 on business metrics 122 using linear regression policy 906. Linear regression policy 906 uses business metrics 122 for previous ones of time periods 306 as lagged independent variables to determine an effect of migration events 128. Linear regression policy 906 allows migration modeler 114 to determine the relationship between migration events 128 in previous ones of time periods 306 and the subsequent changes to business metrics 122. The changes to business metrics 122 can include, for example, but not limited to, changes in revenue, stock price, profit, and operating expenses.

In an illustrative example, migration modeler 114 determines an effect of migration events 128 on business metrics 122 using vector auto-regression policy 908. Vector auto-regression policy 908 captures the linear interdependencies of migration events 128 and other relevant events over time periods 306. All of the variables in vector auto-regression policy 908 has an equation explaining their evolution based on its own lagged values and the lagged values of the other model variables. Vector auto-regression policy 908 allows migration modeler 114 to determine how the effects of migration events 128 are evolving with other events that may have an effect on business metrics 122.

In an illustrative example, migration modeler 114 determines an effect of migration events 128 on business metrics 122 using impulse/response policy 910. Impulse/response policy 910 measures the effect of a change in migration events 128 on business metrics 122. Impulse/response policy 910 allows migration modeler 114 to determine whether migration events 128 produced a lasting effect to business metrics 122, or whether business metrics 122 quickly returned to their pre-migration mean.

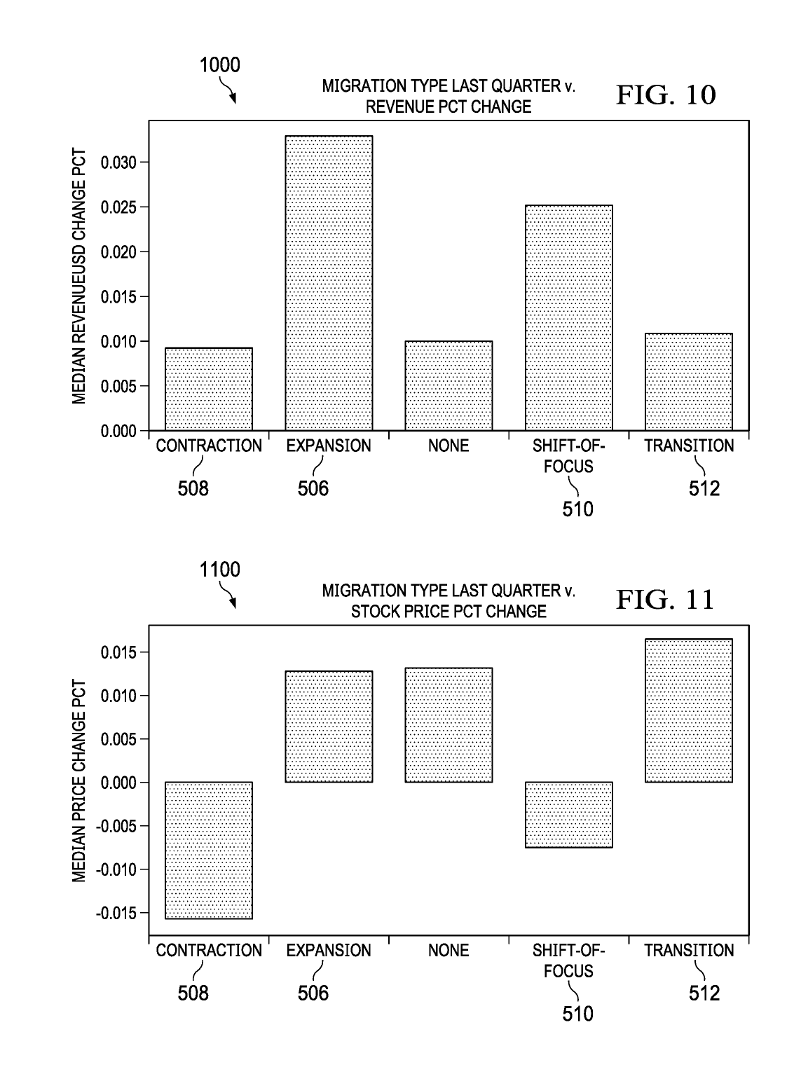

With reference next to FIG. 10, a graph of a first migration metric determined based on a correlation policy is depicted in accordance with an illustrative embodiment. As depicted, graph 1000 illustrates a relationship between migration events 128 and revenue for benchmark organizations 124 of FIG. 1.

As illustrated, revenue is an example of business metrics 122 for benchmark organizations 124, both shown in block form in FIG. 1. In this illustrative example, the effects of migration events 128, including expansion event 506, contraction event 508, shift-of-focus event 510, and transition event 512, are determined using linear regression policy 906 of FIG. 9.

With reference next to FIG. 11, a graph of a second migration metric determined based on a correlation policy is depicted in accordance with an illustrative embodiment. As depicted, graph 1100 illustrates a relationship between migration events 128 and stock price for benchmark organizations 124 of FIG. 1.

As illustrated, stock price is an example of business metrics 122 for benchmark organizations 124, both shown in block form in FIG. 1. In this illustrative example, the effects of migration events 128, including expansion event 506, contraction event 508, shift-of-focus event 510, and transition event 512, are determined using linear regression policy 906 of FIG. 9.

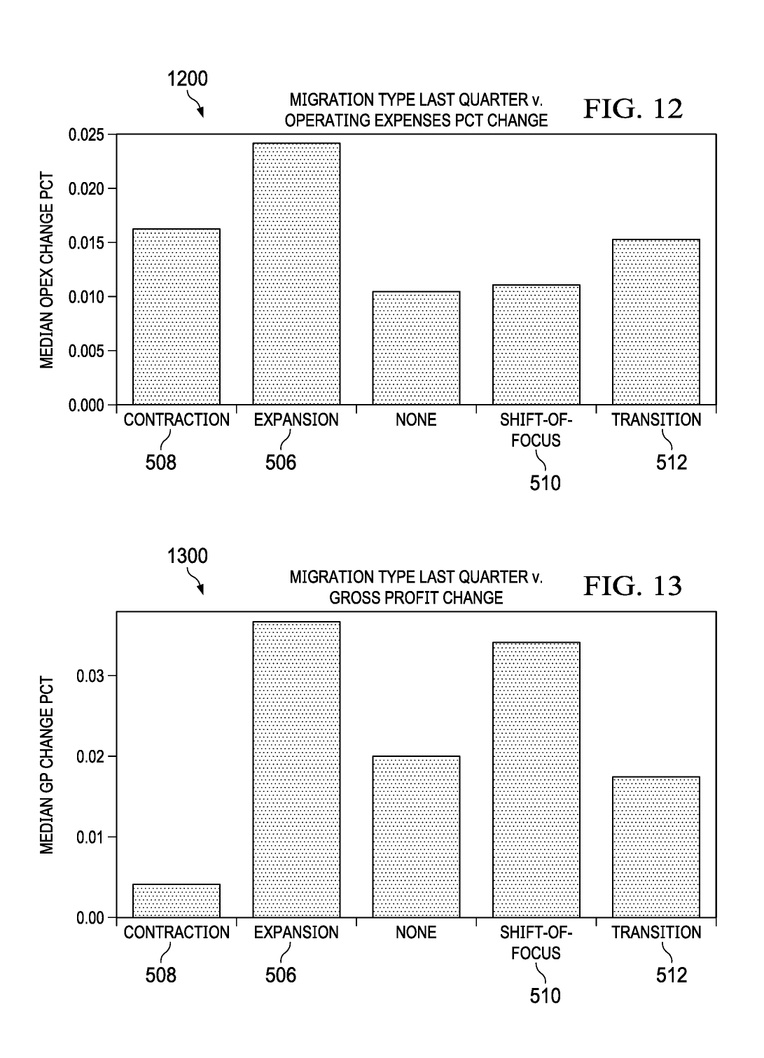

With reference next to FIG. 12, a graph of a third migration metric determined based on a correlation policy is depicted in accordance with an illustrative embodiment. As depicted, graph 1200 illustrates a relationship between migration events 128 and operating expenses for benchmark organizations 124 of FIG. 1.

As illustrated, operating expenses is an example of business metrics 122 for benchmark organizations 124, both shown in block form in FIG. 1. In this illustrative example, the effects of migration events 128, including expansion event 506, contraction event 508, shift-of-focus event 510, and transition event 512, are determined using linear regression policy 906 of FIG. 9.

With reference next to FIG. 13, a graph of a fourth migration metric determined based on a correlation policy is depicted in accordance with an illustrative embodiment. As depicted, graph 1300 illustrates a relationship between migration events 128 and gross profit for benchmark organizations 124 of FIG. 1.

As illustrated, gross profit is an example of business metrics 122 for benchmark organizations 124, both shown in block form in FIG. 1. In this illustrative example, the effects of migration events 128, including expansion event 506, contraction event 508, shift-of-focus event 510, and transition event 512, are determined using linear regression policy 906 of FIG. 9.

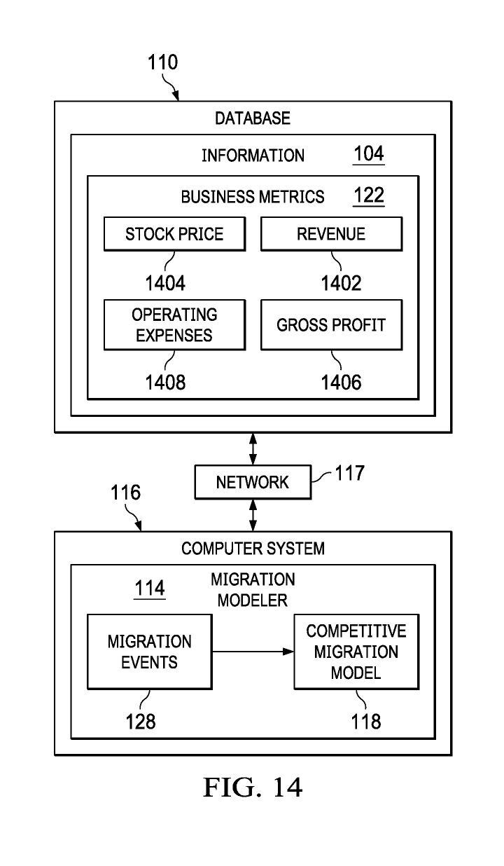

With reference next to FIG. 14, an illustration of a block diagram of a data flow for determining an effect of migration events on business metrics within a human resource modeling system is depicted in accordance with an illustrative embodiment.

In an illustrative example, migration modeler 114 determines an effect of migration events 128 on business metrics 122 using policy 902 of FIG. 9. In this illustrative example, business metrics 122 are business metrics for benchmark organizations 124 of FIG. 1. As depicted, business metrics 122 include revenue 1402, stock price 1404, gross profit 1406, and operating expenses 1408. In this illustrative example, migration modeler 114 determines an effect of migration events 128 on business metrics 122 by identifying a change to business metrics 122 over time periods 306 of FIG. 3.

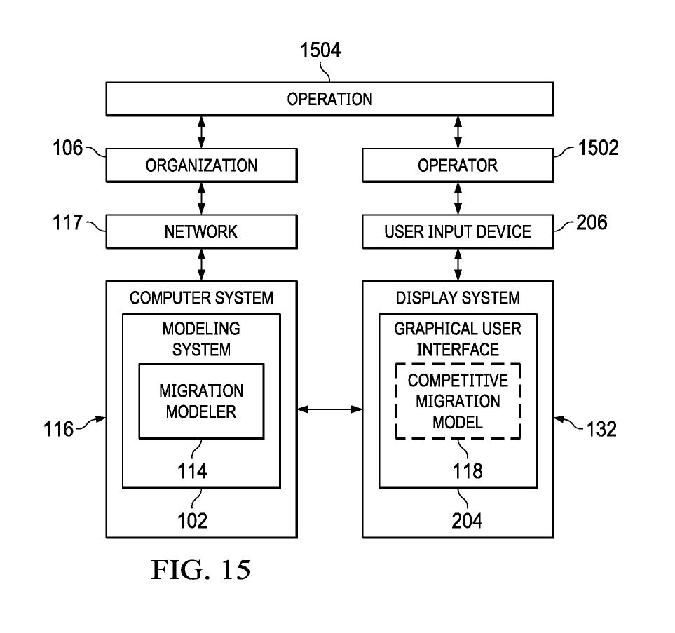

With reference next to FIG. 15, an illustration of a block diagram of a data flow for digitally presenting a competitive human resources migration model within a human resource modeling system and performing operations based thereon is depicted in accordance with an illustrative embodiment.

In this illustrative example, migration modeler 114 digitally presents competitive migration model 118 for organization 106. As depicted, migration modeler 114 digitally presents competitive migration model 118 by displaying competitive migration model 118 on display system 132 within graphical user interface 204.

In this illustrative example, operator 1502 performs operation 1504 for organization 106 based on competitive migration model 118. Operation 1504 is enabled based on competitive migration model 118 for organization 106. As depicted, operator 1502 can perform operation 1504 by interacting with competitive migration model 118 through user input generated by one or more of user input device 206.

Operation 1504 is an operation performed for the benefit of organization 106. Operation 1504 can be, for example, but not limited to, relocation operations, hiring operations, benefits administration operations, payroll operations, performance review operations, forming teams for new products, and assigning research projects. Operation 1504 can be performed as part of a comprehensive human resources capital relocation strategy.

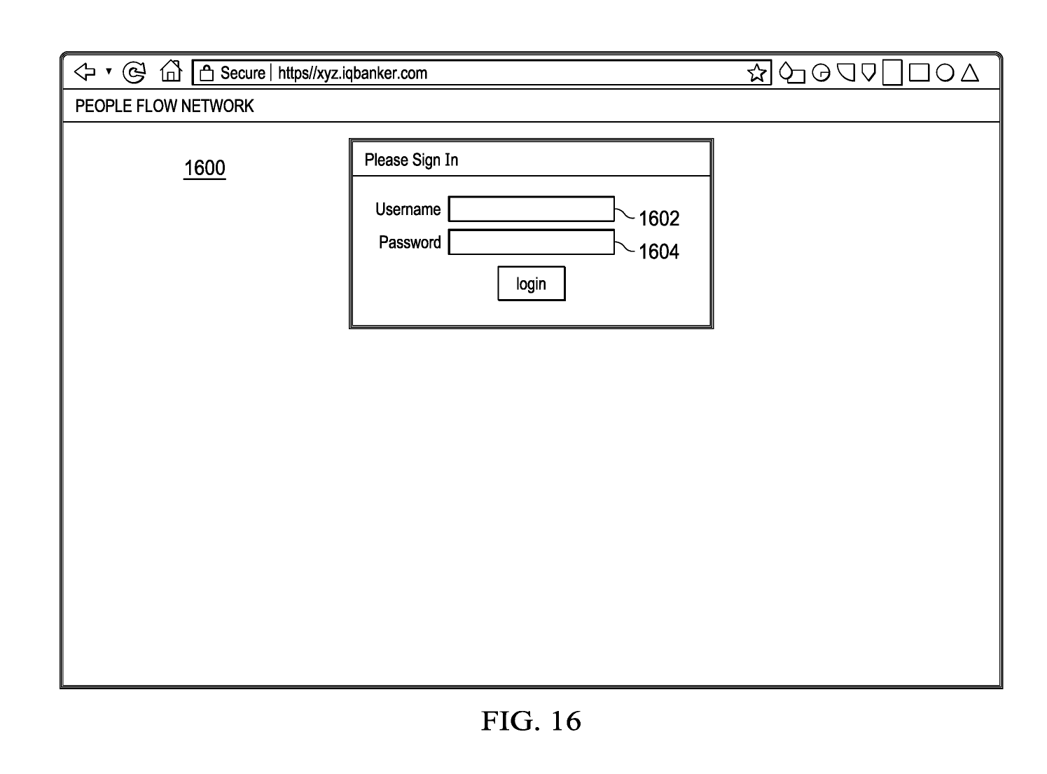

With reference next to FIG. 16, an illustration of a first window of a graphical user interface for digitally presenting a competitive human resources migration model is depicted in accordance with an illustrative embodiment. Window 1600 can be displayed on display system 132 of FIG. 1 within graphical user interface 204 of FIG. 2.

As depicted, window 1600 is a login screen for accessing human resources modeling system 102 of FIG. 1. An operator, such as operator 1502 of FIG. 15, can access human resources modeling system 102 by entering appropriate credentials for graphical elements 1602 and 1604. These credentials can be, for example, a username and a password.

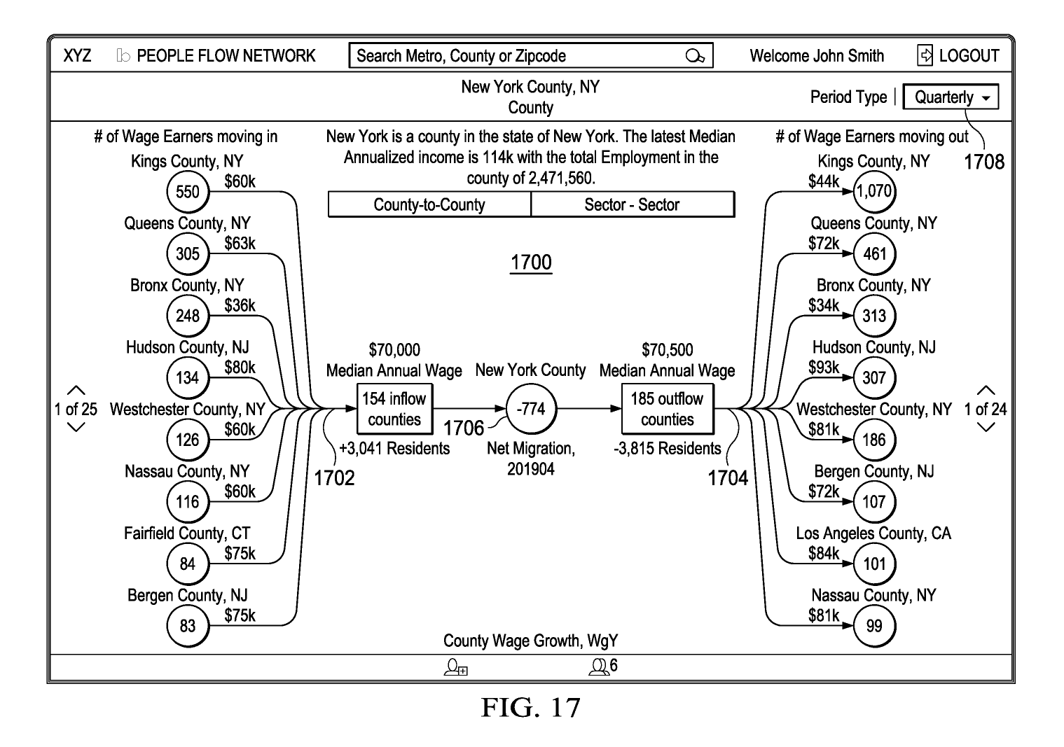

With reference next to FIG. 17, an illustration of a second window of a graphical user interface for digitally presenting a competitive human resources migration model is depicted in accordance with an illustrative embodiment. Window 1700 can be displayed on display system 132 of FIG. 1 within graphical user interface 204 of FIG. 2.

In this illustrative example, window 1700 displays visualization 1702 of first data 308 of FIG. 3, and visualization 1704 of second data 310 of FIG. 3. Visualization 1702 is a visual representation of a number of employees of benchmark organizations that migrate into geographic area 1706 over time period 1708. Geographic area 1706 is an example of one of geographic areas 304 of FIG. 3. Visualization 1704 is a visual representation of a number of employees of benchmark organizations that migrate away from geographic area 1706 over time period 1708.

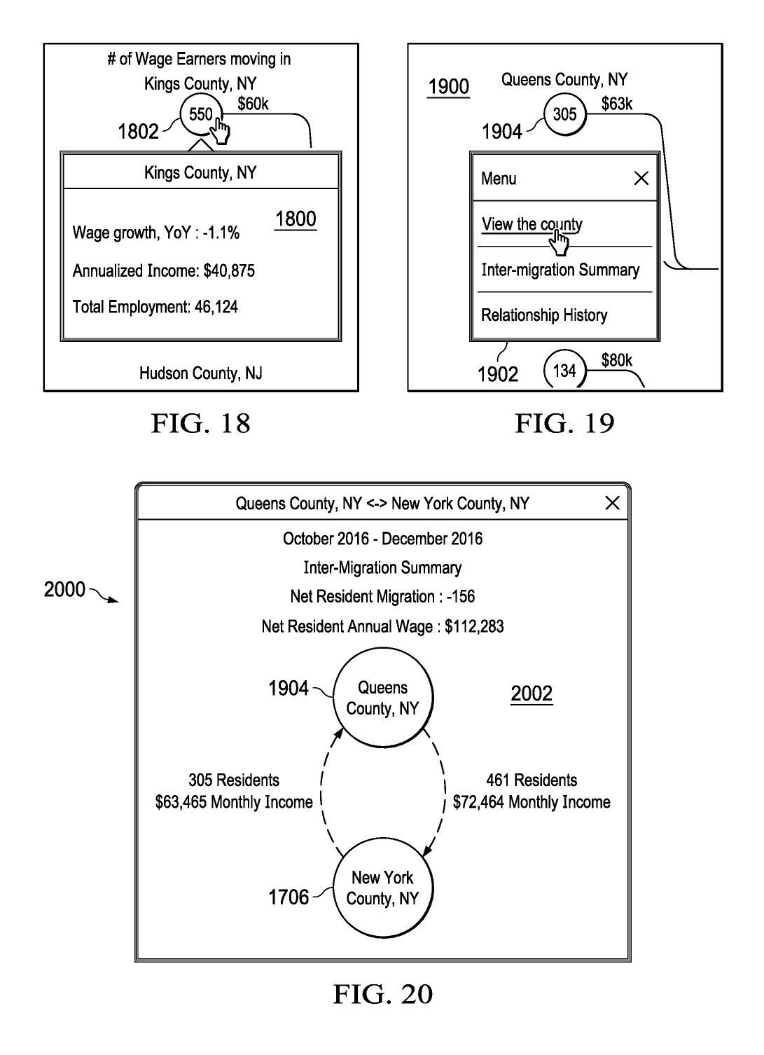

With reference next to FIG. 18, an illustration of a third screen of a graphical user interface migration model for digitally presenting a competitive human resources migration model is depicted in accordance with an illustrative embodiment. Window 1800 can be displayed on display system 132 of FIG. 1 within graphical user interface 204 of FIG. 2.

In this illustrative example, window 1800 displays details regarding employees of benchmark organizations that migrate into geographic area 1802. Window 1800 is displayed in response to a selection of corresponding graphical element from window 1700 of FIG. 17.

With reference next to FIG. 19, an illustration of a fourth screen of a graphical user interface migration model for digitally presenting a competitive human resources migration model is depicted in accordance with an illustrative embodiment. Window 1900 can be displayed on display system 132 of FIG. 1 within graphical user interface 204 of FIG. 2.

In this illustrative example, window 1900 displays pop-up menu 1902. Pop-up menu 1902 includes options for comparing geographic area 1904 to geographic area 1706 of FIG. 7. Pop-up menu 1902 is displayed in response to a selection of a corresponding graphical element from window 1700 of FIG. 17.

With reference next to FIG. 20, an illustration of a fifth screen of a graphical user interface migration model for digitally presenting a competitive human resources migration model is depicted in accordance with an illustrative embodiment. Window 2000 can be displayed on display system 132 of FIG. 1 within graphical user interface 204 of FIG. 2.

In this illustrative example, window 2000 displays visualization 2002 of third data 312 of FIG. 3. Visualization 2002 is a visual representation of a net number of employees of benchmark organizations that migrate between geographic area 1706 and geographic area 1904 over time period 1708. Window 2000 is displayed in response to a selection of a corresponding graphical element from pop-up menu 1902 of FIG. 19.

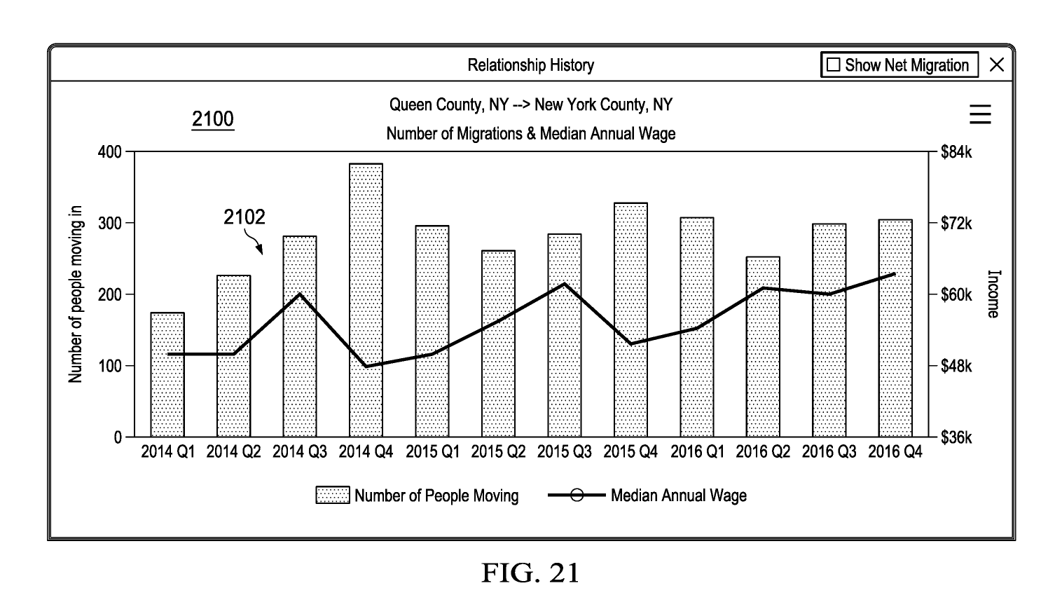

With reference next to FIG. 21, an illustration of a sixth screen of a graphical user interface for digitally presenting a competitive human resources migration model is depicted in accordance with an illustrative embodiment. Window 2100 can be displayed on display system 132 of FIG. 1 within graphical user interface 204 of FIG. 2.

In this illustrative example, window 2100 displays visualization 2102 of an effect of the net number of employees of benchmark organizations that migrate between geographic area 1706 and geographic area 1716 of FIG. 17. As depicted, the effect is an effect on a median annual wage of employees of the benchmark organizations. The median annual wage is an example of business metrics 122 of FIG. 1.

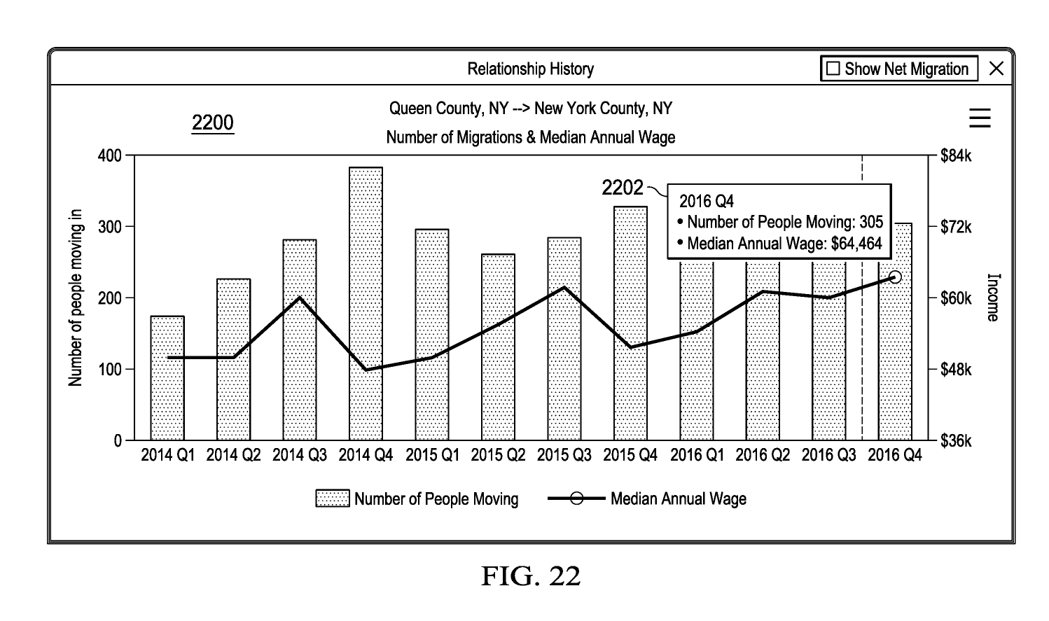

FIG. 22 is an illustration of a seventh screen of a graphical user interface for digitally presenting a competitive human resources migration model depicted in accordance with an illustrative embodiment. Window 2200 can be displayed on display system 132 of FIG. 1 within graphical user interface 204 of FIG. 2.

In this illustrative example, window 2200 displays pop-up window 2202. Pop-up window 2202 provides details about a business effect of a migration event over a particular time period. Pop-up window 2202 is displayed in response to a selection of a corresponding graphical element from window 2100 of FIG. 21.

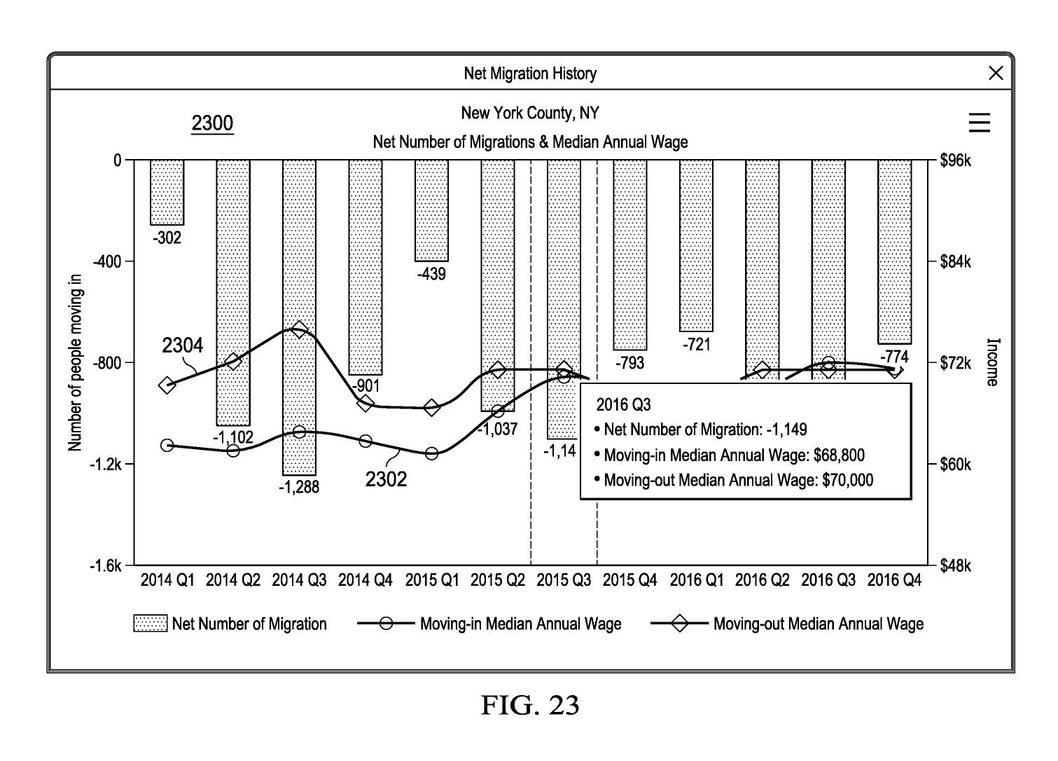

With reference next to FIG. 23, an illustration of an eighth screen of a graphical user interface for digitally presenting a competitive human resources migration model is depicted in accordance with an illustrative embodiment. Window 2300 can be displayed on display system 132 of FIG. 1 within graphical user interface 204 of FIG. 2.

In this illustrative example, window 2300 displays visualization 2302 and visualization 2304 of effects of the net number of employees of benchmark organizations that migrate with respect to geographic area 1706 of FIG. 17. Visualization 2302 displays an effect on a median annual wage of employees of the benchmark organizations migrating into geographic area 1706. Visualization 2304 displays an effect on a median annual wage of employees of the benchmark organizations migrating away from geographic area 1706. The median annual wage is an example of business metrics 122 of FIG. 1.

The illustration of human resources modeling system 102 in FIG. 1 and the different components and examples of implementations in FIGS. 1-23 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

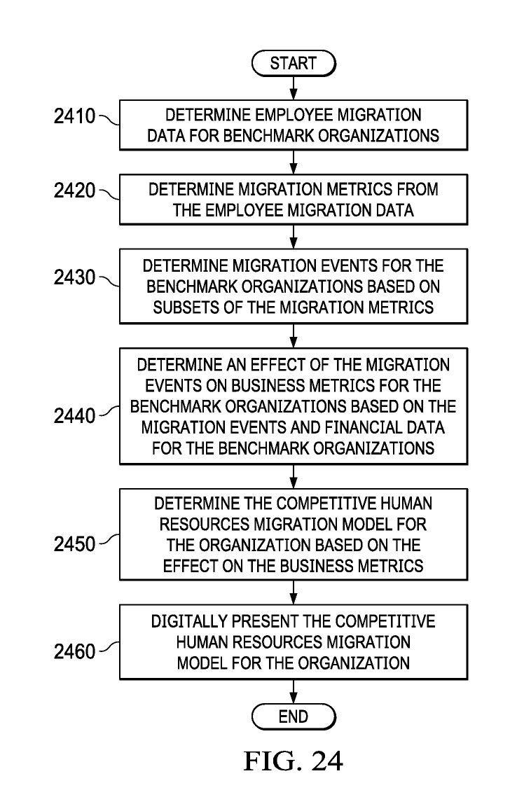

With reference next to FIG. 24, an illustration of a flowchart of a process for digitally presenting a competitive human resources migration model is depicted in accordance with an illustrative embodiment. The process in FIG. 24 may be implemented in migration modeler 114 in FIG. 1. For example, these different steps may be implemented using program code.

The process begins by determining employee migration data for benchmark organizations (step 2410). The process can determine employee migration data for benchmark organizations as illustrated by the data flow of FIG. 3.

The process determines migration metrics from the employee migration data (step 2420). The process can determine migration metrics from the employee migration data as illustrated by the data flow of FIG. 4.

The process determines migration events for the benchmark organizations based on subsets of the migration metrics (step 2430). The process can determine migration metrics from the employee migration data as illustrated by the data flow of FIG. 5.

The process determines an effect of the migration events on business metrics for the benchmark organizations based on the migration events and financial data for the benchmark organizations (step 2440). The process can determine migration metrics from the employee migration data as illustrated by the data flow of FIG. 14.

The process determines the competitive human resources migration model for the organization based on the effect on the business metrics (step 2450). The process can determine the competitive human resources migration model as illustrated by the human resources migration environment of FIG. 1 and the data flow of FIG. 15.

The process digitally presents the competitive human resources migration model for the organization (step 2460), with the process terminating thereafter. The process can determine the competitive human resources migration model as illustrated by the data flow of FIG. 15.

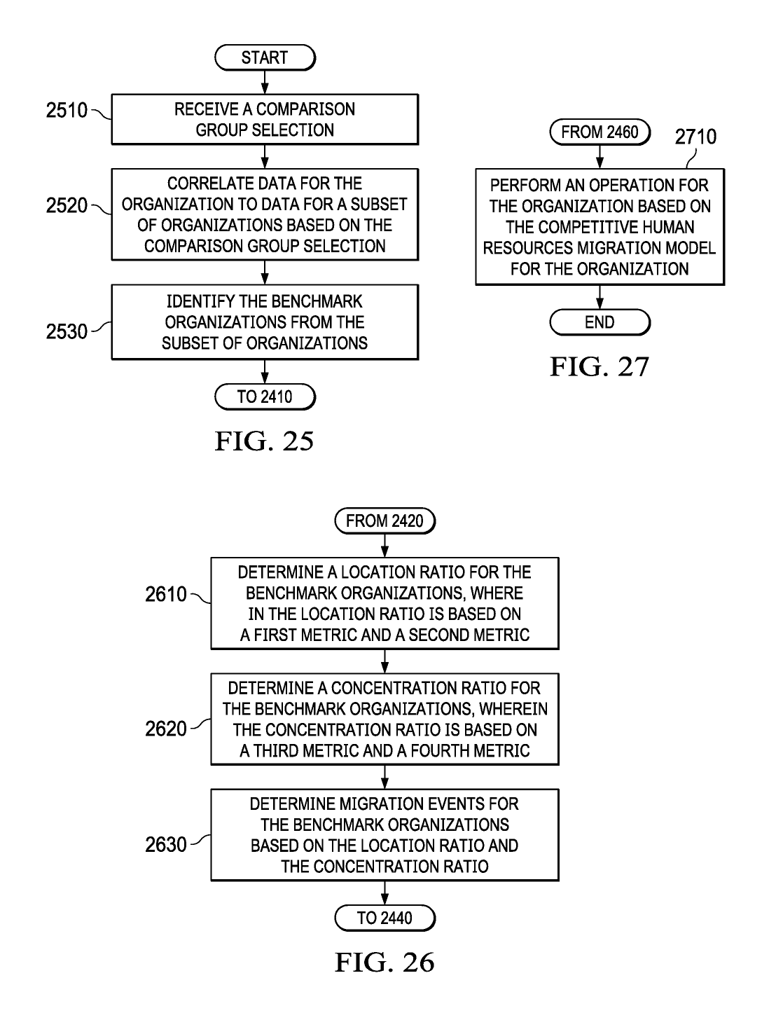

With reference next to FIG. 25, an illustration of a flowchart of a process for determining a set of benchmark organizations is depicted in accordance with an illustrative embodiment. The process in FIG. 25 may be implemented in migration modeler 114 in FIG. 1, as illustrated by the data flow of FIG. 2. For example, these different steps may be implemented using program code.

The process begins by receiving a comparison group selection (step 2510). The selection can be selection 210 of one of comparison groups 202, both shown in block form in FIG. 2.

The process then correlates data for an organization to data for a subset of organizations based on the comparison group selection (step 2520). The subset can be subset 208 of FIG. 2, identified based on similarities between organization data 212 and organizations data 214, both shown in block form in FIG. 2.

The process identifies a set of benchmark organizations from the subset of organizations (step 2430), with the process proceeding to step 2410 of FIG. 24 thereafter.

FIG. 26 is an illustration of a flowchart of a process for determining migration events for a set of benchmark organizations depicted in accordance with an illustrative embodiment. The process in FIG. 26 may be implemented in migration modeler 114 in FIG. 1, as illustrated by the data flow of FIG. 5. For example, these different steps may be implemented using program code. The process in FIG. 26 is a more detailed flowchart of process step 2430 of FIG. 24.

The process begins by determining a location ratio for a set of benchmark organizations, wherein the location ratio is based on a first metric and a second metric (step 2610). The first metric and the second metric can be first metric 402 and second metric 404, respectively, both of FIG. 4. The location ratio can be location ratio 502 of FIG. 5.

The process determines a concentration ratio for the set of benchmark organizations, wherein the concentration ratio is based on a third metric and a fourth metric (step 2620). The third metric and the fourth metric can be third metric 406 and fourth metric 408, respectively, both of FIG. 4. The concentration ratio can be concentration ratio 504 of FIG. 5.

The process then determines migration events for the benchmark organizations based on the location ratio and the concentration ratio (step 2630), with the process proceeding to step 2440 of FIG. 4 thereafter.

FIG. 27 is an illustration of a flowchart of a process for performing an operation for an organization based on a competitive human resources migration model depicted in accordance with an illustrative embodiment. The process in FIG. 27 may be implemented in migration modeler 114 in FIG. 1, as illustrated by the data flow of FIG. 15. For example, these different steps may be implemented using program code.

In response to step 2460 of FIG. 24, the process performs an operation for an organization based on a competitive human resources migration model for the organization (step 2710), with the process terminating thereafter. The operation can be, for example, one of operations 1504 of FIG. 15.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

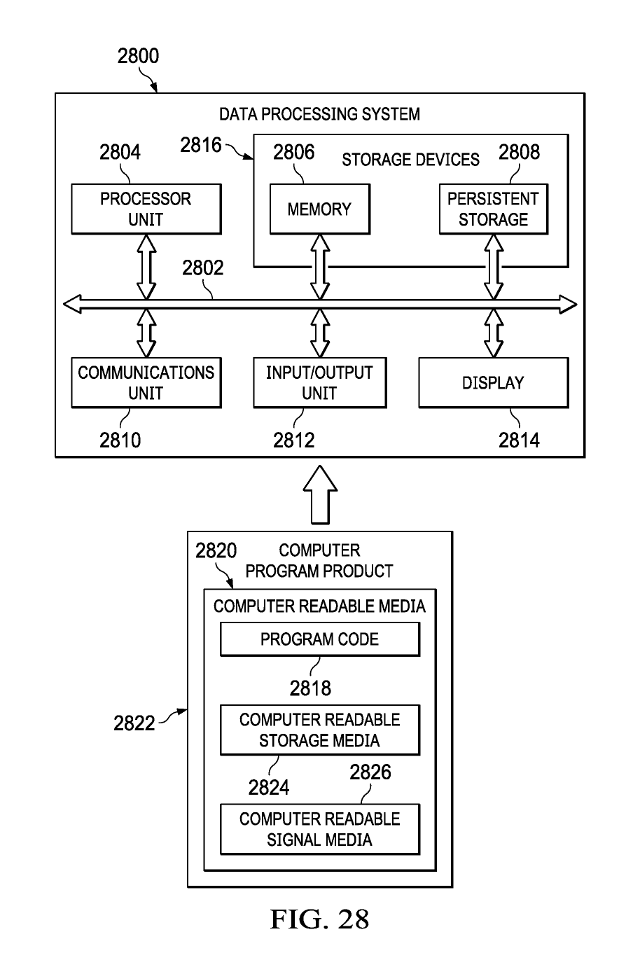

Turning now to FIG. 28, an illustration of a block diagram of a data processing system is depicted in accordance with an illustrative embodiment. Data processing system 2800 may be used to implement human resources modeling system 102, computer system 116, and other data processing systems that may be used in human resources migration environment 100 in FIG. 2. In this illustrative example, data processing system 2800 includes communications framework 2802, which provides communications between processor unit 2804, memory 2806, persistent storage 2808, communications unit 2810, input/output (I/O) unit 2828, and display 2814. In this example, communications framework 2802 may take the form of a bus system.

Processor unit 2804 serves to execute instructions for software that may be loaded into memory 2806. Processor unit 2804 may be a number of processors, a multi-processor core, or some other type of processor, depending on the particular implementation.

Memory 2806 and persistent storage 2808 are examples of storage devices 2816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 2816 may also be referred to as computer readable storage devices in these illustrative examples. Memory 2806, in these examples, may be, for example, a random access memory or any other suitable volatile or non-volatile storage device. Persistent storage 2808 may take various forms, depending on the particular implementation.

For example, persistent storage 2808 may contain one or more components or devices. For example, persistent storage 2808 may be a hard drive, a solid state hard drive, a flash memory, a rewritable optical disk, a rewritable magnetic tape, or some combination of the above. The media used by persistent storage 2808 also may be removable. For example, a removable hard drive may be used for persistent storage 2808.

Communications unit 2810, in these illustrative examples, provides for communications with other data processing systems or devices. In these illustrative examples, communications unit 2810 is a network interface card.

Input/output unit 2812 allows for input and output of data with other devices that may be connected to data processing system 2800. For example, input/output unit 2812 may provide a connection for user input through at least one of a keyboard, a mouse, or some other suitable input device. Further, input/output unit 2812 may send output to a printer. Display 2814 provides a mechanism to display information to a user.

Instructions for at least one of the operating system, applications, or programs may be located in storage devices 2816, which are in communication with processor unit 2804 through communications framework 2802. The processes of the different embodiments may be performed by processor unit 2804 using computer-implemented instructions, which may be located in a memory, such as memory 2806.

These instructions are referred to as program code, computer usable program code, or computer readable program code that may be read and executed by a processor in processor unit 2804. The program code in the different embodiments may be embodied on different physical or computer readable storage media, such as memory 2806 or persistent storage 2808.

Program code 2818 is located in a functional form on computer readable media 2820 that is selectively removable and may be loaded onto or transferred to data processing system 2800 for execution by processor unit 2804. Program code 2818 and computer readable media 2820 form computer program product 2822 in these illustrative examples. In one example, computer readable media 2820 may be computer readable storage media 2824 or computer readable signal media 2826.

In these illustrative examples, computer readable storage media 2824 is a physical or tangible storage device used to store program code 2818 rather than a medium that propagates or transmits program code 2818.

Alternatively, program code 2818 may be transferred to data processing system 2800 using computer readable signal media 2826. Computer readable signal media 2826 may be, for example, a propagated data signal containing program code 2818. For example, computer readable signal media 2826 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 2800 are not meant to provide architectural limitations to the manner in which different embodiments may be implemented. The different illustrative embodiments may be implemented in a data processing system including components in addition to or in place of those illustrated for data processing system 2800. Other components shown in FIG. 28 can be varied from the illustrative examples shown. The different embodiments may be implemented using any hardware device or system capable of running program code 2818.

Thus, one or more of the illustrative examples provide a method and apparatus to overcome the complexities and time needed to determine a competitive human resources capital relocation strategy for an organization. One or more illustrative examples provide a technical solution that involves determining a competitive migration model for an organization based on migration events of other benchmark organizations. Determining a competitive migration model for an organization in this manner reduces the amount of time, effort, or both in the performance of operations for the organization.

The implementation of a human resources modeling system provides an ability to implement a competitive human resources capital relocation strategy for the organization more easily as compared to current systems. For example, the different relocation events of different organizations can be captured and translated into effects on business metrics. When a competitive migration model is determined in this manner, the competitive migration model may be relied upon to perform operations for an organization. The operations can be performed in a manner that is consistent with migration events of benchmark organizations based on changes in business metrics attributed to migration events of those benchmark organizations.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for digitally presenting a competitive human resources migration model for an organization, the method comprising:
determining, by a computer system, employee migration data for benchmark organizations;
determining, by the computer system, migration metrics from the employee migration data;
determining, by the computer system, migration events for the benchmark organizations based on subsets of the migration metrics;
determining, by the computer system, an effect of the migration events on business metrics for the benchmark organizations;
determining, by the computer system, the competitive human resources migration model for the organization based on the effect on the business metrics; and
digitally presenting, by the computer system, the competitive human resources migration model for the organization.

2. The method of claim 1, further comprising:
receiving, by the computer system, a comparison group selection;
correlating, by the computer system, data for the organization to data for a subset of organizations based on the comparison group selection; and
determining, by the computer system, the benchmark organizations from the subset of organizations.

3. The method of claim 1, wherein the employee migration data comprises:
first data that measures a first number of employees for the benchmark organizations that migrate into a geographic area over a time period;
second data that measures a second number of employees for the benchmark organizations that migrate away from the geographic area over the time period; and
third data that measures a net migration of employees for the benchmark organizations in the geographic area over the time period.

4. The method of claim 1, wherein the migration metrics comprises:
a first metric that measures a number of geographic areas into which employees of the benchmark organizations migrate over a time period;
a second metric that measures a number of geographic areas away from which employees of the benchmark organizations migrate over the time period;
a third metric that measures a maximum number of employees of the benchmark organizations that migrated to a particular geographic area; and
a fourth metric that measures a maximum number of employees of the benchmark organizations that migrated away from a particular geographic area.

5. The method of claim 4, wherein determining the migration events further comprises:
determining, by the computer system, a location ratio for the benchmark organizations, where in the location ratio is based on the first metric and the second metric; and
determining, by the computer system, a concentration ratio for the benchmark organizations, wherein the concentration ratio is based on the third metric and the fourth metric.

6. The method of claim 5, wherein determining the migration events further comprises:
determining, by the computer system, the migration events for the benchmark organizations, wherein the migration events are based on the location ratio and the concentration ratio.

7. The method of claim 6, wherein the migration events are selected from:
an expansion event, a contraction event, a shift of focus event, and a transitional event.

8. The method of claim 1, wherein the business metrics for the benchmark organizations are correlated with the migration events using one of a number of correlation policies, wherein the number of correlation policies comprises:
a descriptive statistics policy;
a linear regression policy;
a vector auto-regression policy; and
an impulse response function policy.

9. The method of claim 1, wherein effects on the business metrics comprise:
a change in a stock price of the benchmark organizations;
a change in a revenue of the benchmark organizations;
a change in operating expenses of the benchmark organizations; and
a change in a gross profit of the benchmark organizations.

10. The method of claim 1, further comprising:
performing an operation for the organization based on the competitive human resources migration model for the organization, wherein the operation is enabled based on the competitive human resources migration model.

11. The method of claim 10, wherein the operation is selected from relocation operations, hiring operations, benefits administration operations, payroll operations, performance review operations, forming teams for new products, and assigning research projects.

12. A computer system comprising:
a hardware processor;
a display system; and
a migration modeler in communication with the hardware processor and the display system, wherein the migration modeler:
determines employee migration data for benchmark organizations;
determines migration metrics from the employee migration data;
determines migration events for the benchmark organizations based on subsets of the migration metrics;
determining determines an effect of the migration events on business metrics for the benchmark organizations;
determines a competitive human resources migration model for an organization based on the effect on the business metrics; and
digitally presents the competitive human resources migration model for the organization on the display system.

13. The computer system of claim 12, wherein the migration modeler further:
receives a comparison group selection;
correlates data for the organization to data for a subset of organizations based on the comparison group selection; and
identifies the benchmark organizations from the subset of organizations.

14. The computer system of claim 12, wherein the employee migration data comprises:
first data that measures a first number of employees for the benchmark organizations that migrate into a geographic area over a time period;
second data that measures a second number of employees for the benchmark organizations that migrate away from the geographic area over the time period; and
third data that measures a net migration of employees for the benchmark organizations in the geographic area over the time period.

15. The computer system of claim 12, wherein the migration metrics comprises:
a first metric that measures a number of geographic areas into which employees of the benchmark organizations migrate over a time period;
a second metric that measures a number of geographic areas away from which employees of the benchmark organizations migrate over the time period;
a third metric that measures a maximum number of employees of the benchmark organizations that migrated to a particular geographic area; and
a fourth metric that measures a maximum number of employees of the benchmark organizations that migrated away from a particular geographic area.

16. The computer system of claim 15, wherein in determining the migration events, the migration modeler further:
determines a location ratio for the benchmark organizations, where in the location ratio is based on the first metric and the second metric; and
determines a concentration ratio for the benchmark organizations, wherein the concentration ratio is based on the third metric and the fourth metric.

17. The computer system of claim 16, wherein determining migration classifications further comprises:
determining, by the computer system, the migration events for the benchmark organizations, wherein the migration events are based on the location ratio and the concentration ratio.

18. The computer system of claim 17, wherein the migration events are selected from:
an expansion event, a contraction event, a shift of focus event, and a transitional event.

19. The computer system of claim 12, wherein the business metrics for the benchmark organizations are correlated with the migration events using one of a number of correlation policies, wherein the number of correlation policies comprises:
a descriptive statistics policy;
a linear regression policy;
a vector auto-regression policy; and
an impulse response function policy.

20. The computer system of claim 12, wherein effects on the business metrics comprise:
a change in a stock price of the benchmark organizations;
a change in a revenue of the benchmark organizations;
a change in operating expenses of the benchmark organizations; and
a change in a gross profit of the benchmark organizations.

21. The computer system of claim 12, further comprising:
performing an operation for the organization based on the competitive human resources migration model for the organization, wherein the operation is enabled based on the competitive human resources migration model.

22. The computer system of claim 21, wherein the operation is selected from relocation operations, hiring operations, benefits administration operations, payroll operations, performance review operations, forming teams for new products, and assigning research projects.

23. A computer program product for digitally presenting a competitive human resources migration model for an organization, the computer program product comprising:
a computer readable storage medium;
first program code, stored on the computer readable storage medium, for determining employee migration data for benchmark organizations;
second program code, stored on the computer readable storage medium, for determining, migration metrics from the employee migration data;
third program code, stored on the computer readable storage medium, for determining migration events for the benchmark organizations based on subsets of the migration metrics;
fourth program code, stored on the computer readable storage medium, for determining an effect of the migration events on business metrics for the benchmark organizations;
fifth program code, stored on the computer readable storage medium, for determining the competitive human resources migration model for the organization based on the effect on the business metrics; and
sixth program code, stored on the computer readable storage medium, for digitally presenting the competitive human resources migration model for the organization.

24. The computer program product of claim 23, further comprising:
program code, stored on the computer readable storage medium, for receiving a comparison group selection;
program code, stored on the computer readable storage medium, for correlating data for the organization to data for a subset of organizations based on the comparison group selection; and
program code, stored on the computer readable storage medium, for identifying the benchmark organizations from the subset of organizations.

25. The computer program product of claim 23, wherein the employee migration data comprises:
first data that measures a first number of employees for the benchmark organizations that migrate into a geographic area over a time period;
second data that measures a second number of employees for the benchmark organizations that migrate away from the geographic area over the time period; and
third data that measures a net migration of employees for the benchmark organizations in the geographic area over the time period.

26. The computer program product of claim 23, wherein the migration metrics comprises:
a first metric that measures a number of geographic areas into which employees of the benchmark organizations migrate over a time period;
a second metric that measures a number of geographic areas away from which employees of the benchmark organizations migrate over the time period;
a third metric that measures a maximum number of employees of the benchmark organizations that migrated to a particular geographic area; and
a fourth metric that measures a maximum number of employees of the benchmark organizations that migrated away from a particular geographic area.

27. The computer program product of claim 26, wherein the third program code further comprises:
program code, stored on the computer readable storage medium, for determining a location ratio for the benchmark organizations, where in the location ratio is based on the first metric and the second metric; and
program code, stored on the computer readable storage medium, for determining a concentration ratio for the benchmark organizations, wherein the concentration ratio is based on the third metric and the fourth metric.

28. The computer program product of claim 27, wherein the third program code further comprises:
program code, stored on the computer readable storage medium, for determining the migration events for the benchmark organizations, wherein the migration events are based on the location ratio and the concentration ratio.

29. The computer program product of claim 28, wherein the migration events are selected from:
an expansion event, a contraction event, a shift of focus event, and a transitional event.

30. The computer program product of claim 23, wherein the business metrics for the benchmark organizations is correlated with the migration events using one of a number of correlation policies, wherein the number of correlation policies comprises:
a descriptive statistics policy;
a linear regression policy;
a vector auto-regression policy; and
an impulse response function policy.

31. The computer program product of claim 23, wherein the effect on the business metrics comprises:
a change in a stock price of the benchmark organizations;
a change in a revenue of the benchmark organizations;
a change in operating expenses of the benchmark organizations; and
a change in a gross profit of the benchmark organizations.

32. The computer program product of 23, further comprising:
program code, stored on the computer readable storage medium, for performing an operation for the organization based on the competitive human resources migration model for the organization, wherein the operation is enabled based on the competitive human resources migration model.

33. The computer program product of 32, wherein the operation is selected from relocation operations, hiring operations, benefits administration operations, payroll operations, performance review operations, forming teams for new products, and assigning research projects.
